(19) United States
(12) Patent Application Publication
(10) Pub. No.: US 2024/0308319 A1
(43) Pub. Date: Sep. 19, 2024

(54) DRIVE ARRANGEMENT FOR A MOTOR VEHICLE AND MOTOR VEHICLE

(71) Applicant: ZF Friedrichshafen AG, Friedrichshafen (DE)

(72) Inventors: Paul Lenz, Waldkirchen (DE); Markus Eisele, Friedrichshafen (DE)

(73) Assignee: ZF Friedrichshafen AG, Friedrichshafen (DE)

(21) Appl. No.: 18/601,369

(22) Filed: Mar. 11, 2024

(30) Foreign Application Priority Data
Mar. 15, 2023 (DE) 10 2023 202 325.3

(51) Int. Cl. B60K 1/02; B60K 17/16

(52) U.S. Cl. CPC B60K 1/02; B60K 17/165

(57) ABSTRACT

A drive arrangement (5) for a motor vehicle (1) has a first drive axle device (6) for driving with a first axle ratio and a second drive axle device (15) for driving with a second axle ratio. The first drive axle device (6) has a first drive module (7) with a first electric drive machine and the second drive axle device (15) has a second drive module with a second electric drive machine. Also disclosed is a motor vehicle (1) comprising such a drive arrangement (5).

### RELATED APPLICATIONS

This application claims the benefit of and right of priority under 35 U.S.C. § 119 to German Patent Application no. 10 2023 202 325.3, filed on 15 Mar. 2023, the contents of which are incorporated herein by reference in its entirety.

### FIELD OF THE DISCLOSURE

The invention relates to a drive arrangement for a motor vehicle, the drive arrangement comprising a first drive axle device for driving with a first axle ratio and a second drive axle device for driving with a second axle ratio. The invention also relates to a motor vehicle.

### BACKGROUND

A drive arrangement is known from document DE 10 2015 112 850 A1 for a motor vehicle comprising a drive front axle and a drive rear axle, with a drive unit generating a drive torque on a drive shaft, a transmission unit connected to the drive shaft by a clutch, and a distributor device connected to a transmission output shaft for optionally transferring the drive torque to the front drive axle and/or the rear drive axle, wherein the distribution device is adapted such that the drive torque is transferred in a first, lower speed range of the drive axles with a first gear ratio to a front drive axle and rear drive axle and is transferred in a second, upper speed range of the drive axles with a second gear ratio to the other of the front drive axle and the rear drive axle.

### SUMMARY

The underlying object of the invention is also to structurally and/or functionally improve the aforementioned drive arrangement. The invention is also based on the task of structurally and/or functionally improving a motor vehicle mentioned at the beginning.

The object is further achieved with a drive arrangement and a vehicle as disclosed herein. Advantageous embodiments and/or further developments will be apparent from the present disclosure.

The drive arrangement can be adapted for use in a drive train and/or in a motor vehicle. The first drive axle device and the second drive axle device can each comprise a differential gear. The first drive axle device and the second drive axle device can each comprise two side shafts. The side shafts can be adapted and/or arranged to drive vehicle wheels.

The first drive axle device and the second drive axle device can be different. The first drive axle device and the second drive axle device can have different axle ratios. The first drive axle device can have a greater axle ratio than the second drive axle device. The first axle ratio can be adapted with regard to a high driving force on the vehicle wheels. The second drive axle device can have a small axle ratio than the first drive axle device. The second axle ratio can be adapted with regard to a high drive speed on the vehicle wheels.

The first drive module can comprise power electronics for the first electric drive machine. The second drive module can comprise power electronics for the second electric drive machine. The first drive module and the second drive module can be controlled in a coordinated manner.

The first drive module can comprise a first transmission device. The first transmission device can comprise a plurality of shiftable gear ratio levels. The gear ratio levels can have different gear ratios. The first transmission device can be adapted as a countershaft transmission. The first transmission device can comprise a first shifting device for shifting the gear ratio stages. The first transmission device can be shiftable into a neutral position.

The second drive module can comprise a second transmission device. The second transmission device can comprise a plurality of shiftable gear ratio levels. The gear ratio levels can have different gear ratios. The second transmission device can be adapted as a countershaft transmission. The second transmission device can comprise a second shifting device for shifting the gear ratio levels. The second transmission device can be shiftable into a neutral position.

The first drive module and the second drive module can have an identical design. The first drive module and the second drive module can be structurally and/or functionally the same. The first drive module and the second drive module can be structurally and/or functionally different.

The first drive axle device can comprise standardized drive module interfaces. The second drive axle device can comprise standardized drive module interfaces. The first drive axle device and the second drive axle device can have structurally and/or functionally corresponding drive module interfaces.

The first drive module can have standardized interfaces. The first drive module can have interfaces compatible with the drive module interfaces. The second drive module can have standardized interfaces. The second drive module can have interfaces compatible with the drive module interfaces.

The first drive axle device can comprise first end transmissions. The first drive axle device can have a first end transmission for each vehicle wheel. The first drive axle device can comprise standardized end transmission interfaces. The first drive axle device can be adapted without first end transmissions and/or without end transmission interfaces. The second drive axle device can comprise second end transmissions. The second drive axle device can have a second end transmissions for each vehicle wheel. The second drive axle device can comprise standardized end transmission interfaces. The first drive axle device and the second drive axle device can have structurally and/or functionally corresponding end transmission interfaces. The second drive axle device can be adapted without second end transmissions and/or end transmission interfaces.

The first end transmission can have standardized interfaces. The first end transmission can have interfaces compatible with the end transmission interfaces. The first end transmission can be adapted as a hub gear, planetary gear or external planetary gear. The second end transmission can have standardized interfaces. The second end transmission can have interfaces compatible with the end transmission interfaces. The second end transmission can be adapted as a hub gear, planetary gear or external planetary gear.

The first drive axle device, the first drive module, the first end transmission, the second drive axle device, the second drive module and/or the second end transmission can form a modular drive system. The modular drive system can comprise drive modules with different designs. The modular drive system can comprise drive modules with different drive machine designs. The modular drive system can comprise drive modules with different transmission designs. The modular drive system can comprise different end transmission designs. The first drive module, the first end transmission, the second drive module, and/or the second end transmission can be selected from the modular drive system. The first drive module, the first end transmission, the second drive module, and/or the second end transmission can be drive modules and/or end transmissions specifically designed from the modular drive system.

The drive arrangement can comprise at least one further drive axle device. The at least one further drive axle device can comprise at least one structural and/or functional feature of the first drive axle device and/or the second drive axle device. A drive module of the at least one further drive axle device can be controlled in a coordinated manner with other drive modules.

The motor vehicle can be a utility vehicle, a truck, or a bus. The motor vehicle can be an electric vehicle or a hybrid electric vehicle. The motor vehicle can comprise at least one additional motor vehicle axle. The at least one further vehicle axle can be a non-driven and/or steerable vehicle axle. The motor vehicle can in particular comprise the drive formula 6×4 or 8×4. The motor vehicle can be driven by means of the first drive module, by means of the second drive module and/or by means of a drive module of at least one further drive axle device.

The invention reduces expenses such as development expenses, process expenses, coordination expenses, manufacturing expenses, assembly expenses, maintenance expenses, and/or cost expenses. Flexibility is increased, especially with regard to product cycles, adaptability, product variety. A drive with several drive machines is possible.

### BRIEF DESCRIPTION OF THE DRAWINGS

A design example of the invention is described in more detail in the following with reference to a figure. Schematically and by way of example, these show in:

FIG. 1 a motor vehicle with two drive axle devices for driving with two electric drive machines and different axle ratios,

FIG. 2 a first drive axle device of a motor vehicle for driving with a high drive force and

FIG. 3 a second drive axle device of a motor vehicle for driving with a high drive force.

### DETAILED DESCRIPTION

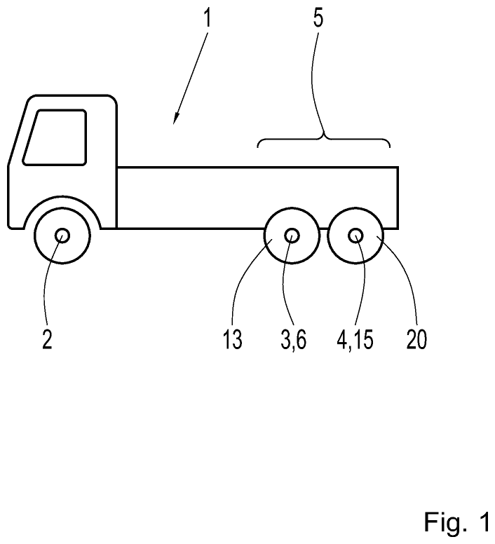

FIG. 1 shows a 6×4 motor vehicle 1 with a non-driven motor vehicle axle 2, a first driven motor vehicle axle 3 and a second driven motor vehicle axle 4. The driven motor vehicle axles 3, 4 form a drive arrangement 5.

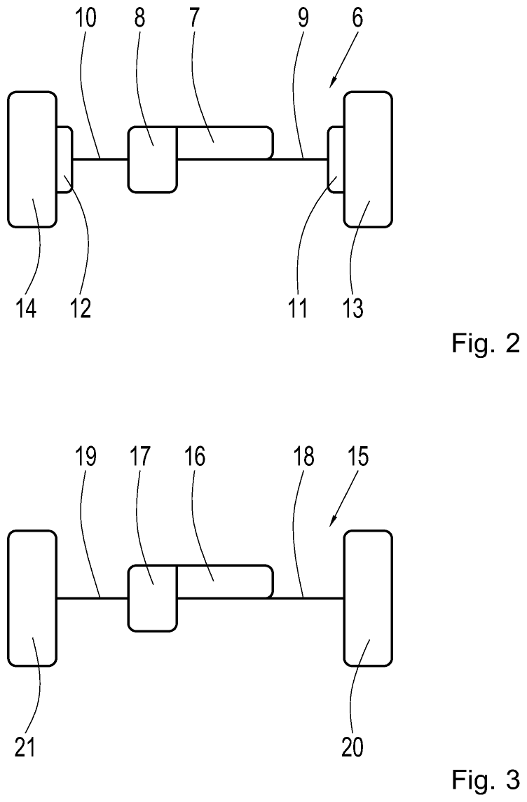

The first motor vehicle axle 3 comprises a first drive axle device 6. FIG. 2 shows the first drive axle device 6. The first drive axle device 6 comprises a first drive module 7 with an electric drive machine and a transmission system, a differential gear 8, two side shafts 9, 10, two end transmissions 11, 12 and two vehicle wheels 13, 14. The drive machine and the transmission device of the first drive module 7 are arranged in a common housing. The drive machine of the first drive module 7 comprises a stator fixed to the housing and a rotor. The transmission system of the first drive module 7 is adapted as a countershaft transmission and comprises a transmission input, a plurality of shiftable gear levels with different gear ratios for representing gears of the first drive axle device 6, a transmission output and a shifting device for shifting the gears. The rotor of the drive machine and the transmission input of the transmission device of the first drive module 7 are mechanically operatively connected to one another to transmit a drive power. The differential gear 8 has one differential gear input and two differential gear outputs. The transmission output of the transmission device of the first drive module 7 and the differential gear input of the differential gear 8 are mechanically operatively connected to one another for transmitting a drive power. A differential gear output of the differential gear 8 and a side shaft 9, 10 are each mechanically operatively connected to one another to transmit a drive power. The end transmissions 11, 12 are respectively adapted as external planetary gears and each have an end transmission input and an end transmission output. One side shaft 9, 10 and the end transmission input of an end transmission are mechanically operatively connected to one another to transmit a drive power. Respectively one end transmission output of an end transmission 11, 12 and a vehicle wheel 13, 14 are mechanically operatively connected to one another to transmit a drive power.

The second motor vehicle axle 4 comprises a second drive axle device 15. FIG. 3 shows the second drive axle device 15. The second drive axle device 15 comprises a second drive module 16 with an electric drive machine and a transmission system, a differential gear 17, two side shafts 18, 19 and two vehicle wheels 20, 21. The drive machine and the transmission device of the second drive module 16 are arranged in a common housing. The drive machine of the second drive module 16 comprises a stator fixed to the housing and a rotor. The transmission device of the second drive module 16 is adapted as a countershaft transmission and comprises a transmission input, a plurality of shiftable gear levels with different gear ratios for representing gears of the second drive module 16, a transmission output and a shifting device for shifting the gears. The rotor of the drive machine and the transmission input of the transmission device of the second drive module 16 are mechanically operatively connected to one another to transmit a drive power. The differential gear 17 has one differential gear input and two differential gear outputs. The transmission output of the transmission device of the second drive module 16 and the differential gear input of the differential gear 17 are mechanically operatively connected to one another for transmitting a drive power. A differential gear output of the differential gear 17 and a side shaft 18, 19 are mechanically operatively connected to one another to transmit a drive power. The side shafts 18, 19 and the vehicle wheels 20, 21 are mechanically operatively connected to one another to transmit a drive power.

The drive module of the first drive axle device 6 and the drive module of the second drive axle device 15 have identical designs. The end transmissions 11, 12 of the first drive axle device 6 cause a transmission ratio increase. The first drive axle device 6 thus has a greater axle ratio than the second drive axle device 15. With its first larger axle ratio, the first drive axle device 6 enables a drive of the motor vehicle 1 with a high drive force. With its second smaller axle ratio, the second drive axle device 15 enables a drive of the motor vehicle 1 with a high drive speed.

A modular drive system is formed that comprises drive axle devices, drive modules with different designs, and end transmissions with different designs. The drive axle devices on the one hand and the drive modules and the end transmissions on the other have compatible interfaces. The drive modules 7, 16 and end transmissions 11, 12 of the drive axle devices 6, 8 are specially designed drive modules 7, 16 and end transmissions 11, 12 selected from the modular drive system.

The word “can” refers in particular to optional features of the invention. There are therefore also further developments and/or design examples of the invention which additionally or alternatively comprise the respective feature or features.

If necessary, isolated features can also be selected from the combinations of features disclosed here and can be used in combination with other features to delimit the subject matter of the claim, while resolving a structural and/or functional relationship that may exist between the features.

### LIST OF REFERENCE NUMERALS

1 Motor vehicle
2 Non-driven motor vehicle axle
3 First driven motor vehicle axle
4 Second driven motor vehicle axle
5 Drive arrangement
6 First drive axle device
7 Drive module
8 Differential gear
9 Side shaft
10 Side shaft
11 End transmission
12 End transmission
13 Vehicle wheel
14 Vehicle wheel
15 Second drive axle device
16 Drive module
17 Differential transmission
18 Side shaft
19 Side shaft
20 Vehicle wheel
21 Vehicle wheel

1. A drive arrangement (5) for a motor vehicle (1), the drive arrangement (5) comprising:
a first drive axle device (6) configured for driving with a first axle ratio, the first drive axle device comprising a first drive module (7) with a first electric drive machine; and
a second drive axle device (15) configured for driving with a second axle ratio second drive axle device (15) comprising a second drive module with a second electric drive machine.

2. The drive arrangement (5) according to claim 1, wherein the first drive module (7) comprises a first transmission system with a plurality of shiftable gear ratio levels and the second drive module (16) comprises a second transmission system with a plurality of shiftable gear ratio levels.

3. The drive arrangement (5) according to claim 1, wherein the first drive module (7) is identical to the second drive module (16).

4. The drive arrangement (5) according to claim 1, wherein each of the first drive axle device (6) and the second drive axle device (15) has a standardized drive module interface.

5. The drive arrangement (5) according to claim 4, wherein each of the first drive module (7) and the second drive module (16) has an interface that is compatible with a respective drive module interface.

6. The drive arrangement (5) according to claim 1, wherein the first drive axle device (6) comprises first end transmissions (11, 12) and/or the second drive axle device (15) comprises second end transmissions.

7. The drive arrangement (5) according to claim 6, the first drive axle device (6) and/or the second drive axle device (15) has a standardized end transmission interface.

8. The drive arrangement (5) according to claim 7, wherein the first end transmissions (11, 12) and/or the second end transmissions has an interface that is compatible with the end transmission interface.

9. The drive arrangement (5) according to claim 6, wherein the first end transmissions (11, 12) and/or the second end transmissions are adapted as external planetary gears.

10. A motor vehicle (1) comprising the drive arrangement (5) according to claim 1.
